(19) United States
(12) Patent Application Publication
(10) Pub. No.: US 2007/0077182 A1
(43) Pub. Date: Apr. 5, 2007

(54) Container

(75) Inventor: Jeng-Wen Huang, Hsinchu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/368,632

(22) Filed: Mar. 7, 2006

(30) Foreign Application Priority Data
Oct. 4, 2005 (TW) 94134716

(51) Int. Cl. B01L 3/00

(52) U.S. Cl. 422/102

(57) ABSTRACT

A paper container used for containing a plurality of objects, such as slim-typed optical disc drives, is provided. A plurality of upper containing rooms of an upper lid combine with a plurality of lower containing rooms of a lower lid to form object containing rooms. A positioning board is placed between the upper lid and the lower lid. Positioning grids of the positioning board enable the objects to be placed in the object containing rooms more stably.

### BACKGROUND OF THE INVENTION

(1) Field of the Invention

The present invention generally relates to a container, and particularly to a paper container used for containing a plurality of thin-typed objects.

(2) Description of the Prior Art

Paper containers have many advantages, such as light weight, vibration absorbing, environment protection and low cost. Therefore, they are usually used for packing a batch of objects like electronic products.

Please refer to FIG. 1. FIG. 1 illustrates a container 2 according to a prior art. The container 2 comprises an upper lid 4 and a lower lid 6. The upper lid 4 comprises a plurality of upper containing rooms 402. Each of the upper containing rooms 402 extends upwards and opens downwards. The lower lid 6 comprises a plurality of lower containing rooms 602. Each of the lower containing rooms 602 corresponds to one of the upper containing rooms 402. Each of the lower containing rooms 602 extends downwards and opens upwards. The lower lid 6 is disposed under the upper lid 4. As a result, each of the lower containing rooms 402 and the corresponding upper containing room 602 relatively combine together to form an object containing room. An object 8, such as an electronic product (for example, a slim-typed optical disc drive as shown in FIG. 1), is contained in one of the object containing rooms.

The container 2 is made of paper and formed by a mold. For being easily taken off from the mold during manufacturing, the side walls 402w of the upper containing rooms 402 and the side walls 602w of the lower containing rooms 602 are inclined (such as an inclination of 3° in FIG. 1). Each of the upper containing rooms 402 becomes wider from top to bottom, and each of the lower containing rooms 602 becomes wider from bottom to top.

In the general process of packing the object 8 into one of the object containing rooms, the lower lid 6 is placed first. Next, the object 8 is placed into one of the lower containing rooms 602. Then, the upper lid 4 is placed so that the corresponding upper containing room 402 covers the object 8. Afterwards, the whole container 2 is placed into a paper box.

However, the thickness of the object 8, such as a slim-typed optical disc drive, is less than the width of the upper containing room 402. The thickness of the object 8 is less than the width of the lower containing room 602 as well. Therefore, after the object 8 is placed into one of the lower containing rooms 602, the object 8 is usually inclined. Especially after several objects 8 are placed into some of the lower containing rooms 602, the inclining directions of the objects 8 are different from each other. When the upper lid 4 is placed, the opening edges of the upper containing rooms 402 interfere the upper parts of the objects 8. As a result, it is not easy to place the upper lid 4 on the lower lid 6 properly, and the packing efficiency is decreased.

Therefore, the main objective of the present invention is to provide a paper container used for containing a plurality of thin-typed objects in order to solve the above-described problem.

### SUMMARY OF THE INVENTION

An objective of the present invention is to provide a paper container used for containing a plurality of thin-typed objects. When the upper lid is placed on the lower lid containing the thin-typed objects, the provided paper container avoids the edges of the upper containing rooms of the upper lid to interfere the upper parts of the objects. Therefore, it is faster and more convenient to pack the thin-typed objects.

The present invention relates to a paper container used for containing a plurality of objects, such as slim-typed optical disc drives. The container comprises an upper lid, a lower lid and a positioning board.

The upper lid comprises a plurality of upper containing rooms. Each of the upper containing rooms extends upwards and opens downwards. Each of the upper containing rooms becomes wider from top to bottom.

The lower lid comprises a plurality of lower containing rooms. Each of the lower containing rooms corresponds to one of the upper containing rooms. Each of the lower containing rooms extends downwards and opens upwards. Each of the lower containing rooms becomes wider from bottom to top. The lower lid is placed under the upper lid so that each of the lower containing rooms and the corresponding upper containing room combine relatively to form an object containing room.

The positioning board is placed between the upper lid and the lower lid. The positioning board has a plurality of positioning grids. Each of the positioning grids corresponds to one of the object containing rooms. The width of the positioning grid is less than the width of a lower opening of the upper containing room. The width of the positioning grid is less than the width of an upper opening of the lower containing room. Each of the object is placed in one of the object containing rooms through one of the positioning grids.

When the upper lid is placed on the lower lid containing the thin-typed objects, the positioning board comprising the positioning grids avoids the thin-typed objects to incline, and the edges of the upper containing rooms will not interfere the upper parts of the objects. Therefore, it is faster and more convenient to pack the thin-typed objects by the paper container according to the present invention.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which

FIG. 1 illustrates a container according to a prior art.

FIG. 2 is a cross-sectional side view of the container according to the present invention.

FIG. 3 illustrates a cutting of the positioning board and the baffles according to the present invention.

FIG. 4 is a sectional front view of the baffles in FIG. 3.

FIG. 5 further illustrates the positioning board according to the present invention.

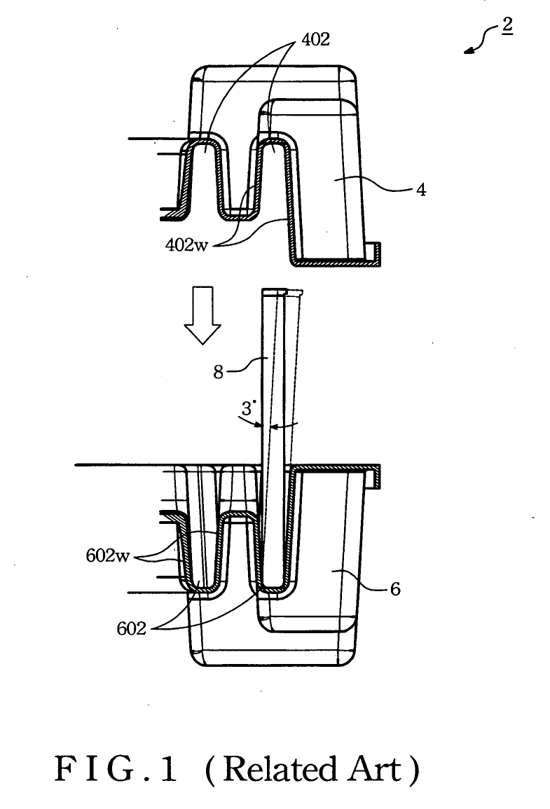

### DESCRIPTION OF THE PREFERRED EMBODIMENT

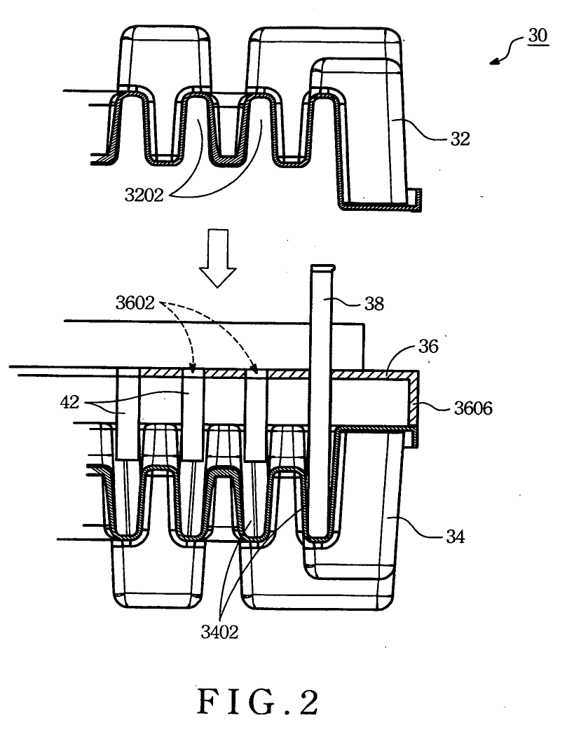

Please refer to FIG. 2, it is a cross-sectional side view of a container 30 according to the present invention. The present invention relates to the paper container 30. The container 30 is used for containing a plurality of objects 38, such as slim-typed optical disc drives. FIG. 2 shows only one object 38 for illustration. The container 30 comprises an upper lid 32, a lower lid 34 and a positioning board 36.

The upper lid 32 comprises a plurality of upper containing rooms 3202. Each of the upper containing rooms 3202 extends upwards and opens downwards. Each of the upper containing rooms 3202 becomes wider from top to bottom.

The lower lid 34 comprises a plurality of lower containing rooms 3402. Each of the lower containing rooms 3402 corresponds to one of the upper containing rooms 3202. Each of the lower containing rooms 3402 extends downwards and opens upwards. Each of the lower containing rooms 3402 becomes wider from bottom to top. The lower lid 34 is disposed under the upper lid 32, so that each of the lower containing rooms 3402 and the corresponding upper containing room 3202 combine relatively to form an object containing room.

The positioning board 36 is disposed between the upper lid 32 and the lower lid 34. The positioning board 36 has a plurality of positioning grids 3602. Each of the positioning grids 3602 corresponds to one of the object containing room. The width of the positioning grid 3602 is less than the width of a lower opening of the upper containing room 3202. The width of the positioning grid 3602 is less than the width of an upper opening of the lower containing room 3402. The object 38 is placed in one of the object containing rooms through one of the positioning grids 3602.

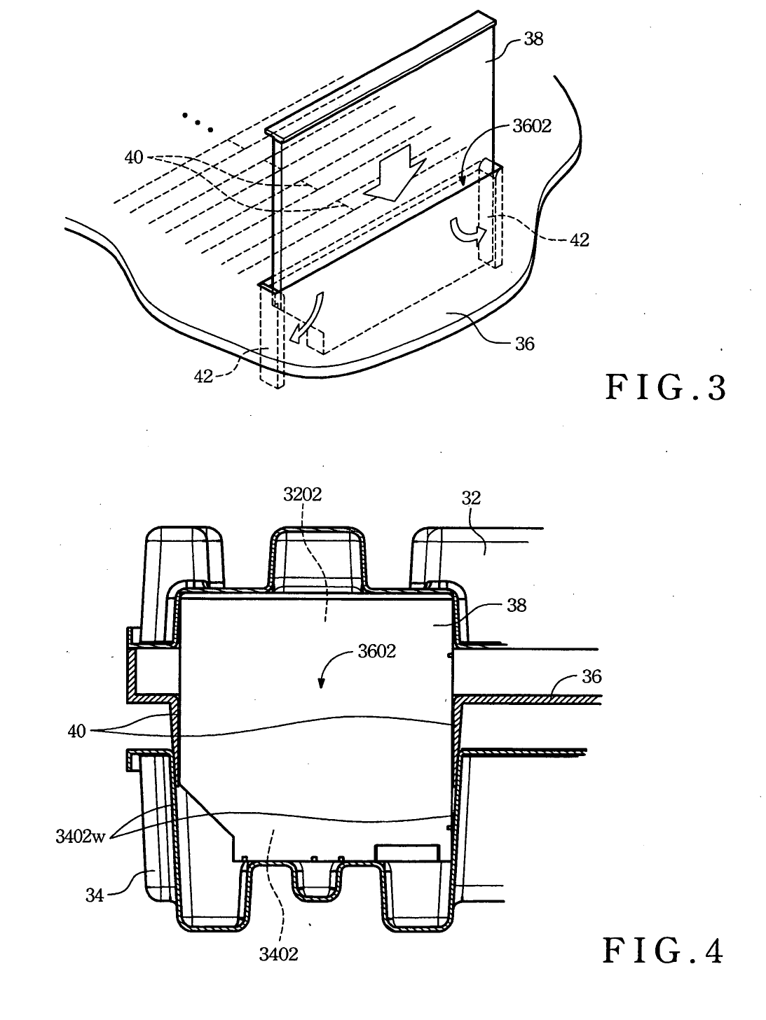

Please further refer to FIG. 3 according to FIG. 2. FIG. 3 illustrates a cutting 40 of the positioning board 36 and baffles 42 according to the present invention. In the above-described container 30, each of the positioning grids 3602 of the positioning board 36 is formed by the cutting 40 to form two baffles 42. The cutting 40 is formed by cutting two parallel lines and one perpendicular line between the parallel lines. When the object 38 is placed into one of the positioning grids 3602, the two baffles 42 are bent downward by a downward force. Then, the two baffles 42 open leftward and rightward respectively. Meanwhile, the space where the two baffles 42 are formed originally becomes one of the positioning girds 3602.

Please further refer to FIG. 4. FIG. 4 is a sectional front view of the baffles 42 in FIG. 3. In FIG. 4, the two baffles 42 are bent downward and then open leftward and rightward respectively, for forming one of the positioning grids 3602. The baffles 42 extend outward and contact with side walls 3402w of one of the lower containing rooms 3402. Meanwhile, the baffles 42 contact with the object 38 as well, so that the baffles 42 are placed between the object 38 and the side walls 3402w. As a result, the object 38 is more stable.

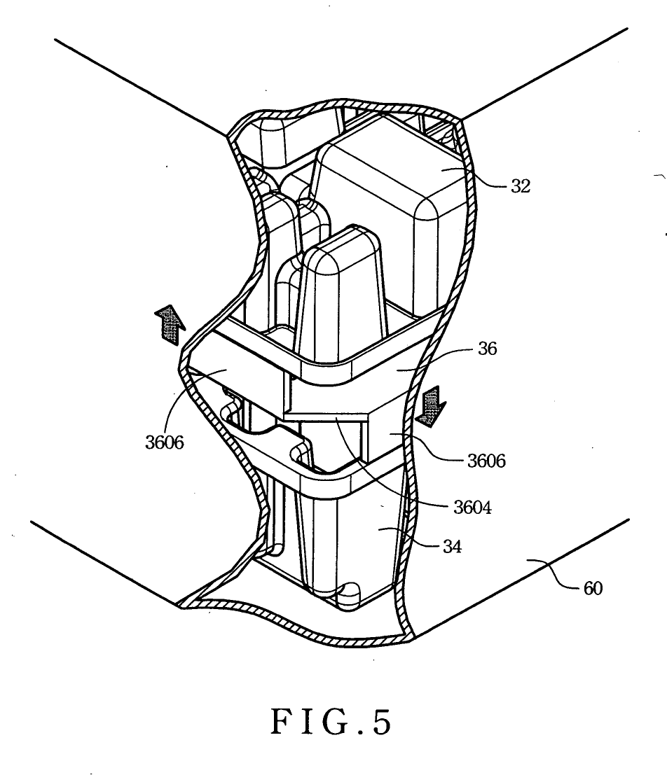

Please further refer to FIG. 5 according to FIG. 2. FIG. 5 further illustrates the positioning board 36 according to the present invention. After the object 38 is placed in the container 30, the container 30 is placed in a box 60. The box 60 is usually made of paper. The edges of upper lid 32, the lower lid 34 and the positioning board 36 contact with inner walls of the box 60, so that the whole container 30 can be stable.

For enabling the container 30 to be placed into and taken out from the box 60 easily, four corners of the positioning board 36 are cut to form four cutting corners 3604. Therefore, the container 30 can be placed into and taken out from the box 60 easily.

Moreover, a predetermined distance can be formed between the upper lid 32 and the lower lid 34. Several supporting walls 3606 extend from edges of the positioning board 36 to contact with the upper lid 32 or the lower lid 34. The sides of the supporting walls 3606 can contact with the box 60. As a result, the predetermined distance can be formed between the upper lid 32 and the lower lid 34, and the positioning board 36 can be more stable.

When the upper lid 32 is placed on the lower lid 34 containing the thin-typed object 38, the positioning board 36 comprising the positioning grids 3602 can avoid the object 38 to incline, and the edges of the upper containing rooms 3202 of the upper lid 32 will not interfere the upper part of the object 38. Therefore, it is faster and more convenient to pack the thin-typed object 38 by the paper container 30 according to the present invention.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A container used for containing a plurality of objects, wherein the container comprises:
a upper lid comprising a plurality of upper containing rooms, each of the upper containing rooms extending upwards and opening downwards, each of the upper containing rooms becoming wider from top to bottom;
a lower lid comprising a plurality of lower containing rooms, each of the lower containing rooms corresponding to one of the upper containing rooms, each of the lower containing rooms extending downwards and opening upwards, each of the lower containing rooms becoming wider from bottom to top, wherein the lower lid is disposed under the upper lid so that each of the lower containing rooms and the corresponding upper containing room relatively combine together to form an object containing room; and
a positioning board disposed between the upper lid and the lower lid, the positioning board having a plurality of positioning grids, each of the positioning grids disposed relatively to one of the object containing rooms, the width of the positioning grid being less than the width of a lower opening of the upper containing room, the width of the positioning grid being less than the width of an upper opening of the lower containing room, wherein each of the objects is placed in one of the object containing rooms through one of the positioning grids.

2. The container of claim 1, wherein the upper lid and the lower lid are made of paper.

3. The container of claim 1, wherein the object is a slim-typed optical disc drive.

4. The container of claim 1, wherein the container is placed in a box, the edges of the upper lid, the lower lid and the positioning board contacting with inner walls of the box.

5. The container of claim 1, wherein four corners of the positioning board are cut to form four cutting corners.

6. The container of claim 1, wherein the container further comprises a supporting wall extending from an edge of the positioning board to contact with the upper lid or the lower lid, for forming a predetermined distance between the upper lid and the lower lid.

7. The container of claim 1, wherein each of the positioning grids of the positioning board is formed by cutting two parallel lines and one perpendicular line between the parallel lines to form two baffles, when the object being placed in the one of the positioning grids, the two baffles being bent downward and then opening leftward and rightward respectively.
